(19) United States
(12) Patent Application Publication
(10) Pub. No.: US 2026/0120018 A1
(43) Pub. Date: Apr. 30, 2026

(54) COMPUTE ENGINE(S) FOR RECOMMENDING SERVICE-BASED COMPUTE CONFIGURATIONS

(71) Applicant: Microsoft Technology Licensing, LLC, Redmond, WA (US)

(72) Inventors: Yanyan JU, Bellevue, WA (US); Alexander Geoffrey HOWELLS, Sammamish, WA (US); Ivona Deborah Agnela FURTADO, Redmond, WA (US); Rama Mohan Rao DINTAKURTHI, Redmond, WA (US); Mark Albert CALIFANO, Mukilteo, WA (US); Vishwa Shobhit SAHAY, Redmond, WA (US); David FIGUEIRAS GARCIA, Seattle, WA (US); Haris Farhan MOHAMMAD, Kirkland, WA (US); Feliks I. SHOSTAK, Snohomish, WA (US)

(21) Appl. No.: 18/925,706

(22) Filed: Oct. 24, 2024

(51) Int. Cl. G06Q 10/0631

(52) U.S. Cl. CPC G06Q 10/06315

(57) ABSTRACT

Systems and methods herein provide a compute engine and its related functions. In an aspect, a compute engine may determine current resources that are provisioned to provide a service within a cloud-based or hybrid environment. The compute engine may determine a provisioning profile for the current resources, including the hardware and software specifications of the current resources. The compute engine may also determine a current utilization of the current resources by the service based on the provisioning profile. Based on the current utilization, the compute engine may determine a current compute landscape including supply data for a grouping of compute configurations. From the compute configurations, the compute engine may select a compute configuration for the service based on the utilization of the current resources and the current compute landscape.

### TECHNICAL FIELD

Aspects of the disclosure are related to the field of computer software applications and services and, in particular, to compute engines for identifying compute configurations tailored to respective services.

### BACKGROUND

In the modern era, organizations and businesses are increasingly turning to cloud-based and hybrid environments to deliver services to consumers more efficiently and effectively. Cloud-based environments leverage virtual machines (VMs) to support a wide range of services, such as web-based applications, by simulating the functionality of physical hardware. Within cloud-based environments, VMs are created by provisioning a specific set of computing resources, such as CPU, memory, and storage, from a shared pool. These resources are allocated based on the needs of the application or service that the VM will support. Organizations are increasingly transitioning to cloud-based environments over traditional on-premises systems because VMs offer greater flexibility and scalability, allowing organizations to provision required resources without the need for costly hardware investments.

### SUMMARY

Technology disclosed herein includes software applications and services that provide a compute engine, and its related functions. In an aspect, a compute engine may determine a group of resources currently provisioned to provide a service within a cloud-based or hybrid environment. Based on the group of resources, the compute engine may determine a provisioning profile of the group of resources. The provisioning profile may include the hardware specifications and the software specifications of the resources in the group. That is, the provisioning profile may indicate the computing arrangement (e.g., specific configuration and allocation of computing resources such as CPU, memory, storage, and networking) of the resources as a group.

Based on the provisioning profile of the resources, the compute engine may determine a current utilization of the resources by the service. As will be described in greater detail below, this may include determining an operational efficiency of the resources for meeting the workload requirements of the service, and/or a demand efficiency of the resources for meeting an estimated workload requirement of the service at a future date. From the utilization, the compute engine may determine whether the current resources are over-provisioned or under-provisioned for the service.

The compute engine may determine a current compute landscape for the service. This may include identifying multiple compute configurations based on the utilization and/or workload requirements of the service. In some embodiments, identification of the compute configurations may include identifying compute configurations that meet provisioning policies (e.g., security requirements) governing the service. From the compute configurations the compute engine may identify a compute configuration that aligns with the operational requirements and/or provisioning policies of the service. As is described below, this may include selecting the compute configuration that provides the most efficient option such that resources are not over-or under-provisioned for the service, and/or provides a lower cost without forfeiting computing performance.

This Summary is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for providing a compute engine, according to an embodiment herein;

FIG. 2 illustrates an example system in which a compute engine is provided, according to an embodiment provided herein;

FIG. 3 illustrates a process for providing a compute engine and its related functions, according to an embodiment herein;

FIG. 4 illustrates a process for providing one or more functions of a compute engine, according to an embodiment herein;

FIG. 5 illustrates an example flow for providing a compute engine, according to an embodiment herein; and

FIG. 6 shows an example client device suitable for providing a compute engine and related functions, according to an embodiment herein.

### DETAILED DESCRIPTION

In the modern era, organizations and businesses are increasingly transitioning to cloud-based or hybrid environments to bring services to consumers. To provide such services, organizations generally provision computing resources that are tailored to meet specific workload requirements, ensuring that applications and services operate efficiently, maintain high performance, and can scale as demand fluctuates. Organizations may select a resource bundle over on-demand resource allocation because resource bundles offer a more predictable and consistent approach to resource management. By choosing a predefined package of resources, businesses can ensure that their services have the exact computing power needed without the uncertainty of fluctuating availability and costs associated with on-demand provisioning. Additionally, resource bundles often simplify budgeting and cost management, as the pricing is typically fixed, making it easier to forecast expenses. This approach also reduces the operational complexity, allowing organizations to focus more on delivering value to their consumers rather than managing infrastructure.

While resource bundles provide for a simple, straight forward approach to provisioning resources, one problem encountered with resource bundles is over-provisioning and under-provisioning. When organizations select a resource bundle, they typically base their decision on estimated operational requirements for the service in question. However, these estimations can often be inaccurate or based on certain assumptions that may not play out once the services are deployed, leading to inefficiencies. Over-provisioning occurs when the selected resource bundle provides more computing power, memory, or storage than the service actually requires, resulting in wasted resources and increased costs. Conversely, under-provisioning happens when the resource bundle falls short of the service's actual needs, leading to performance bottlenecks, slower response times, and potential service disruptions. These issues arise because the operational demands of a service can vary significantly from initial estimations due to changes in user behavior, unexpected traffic spikes, or evolving application requirements. As a result, the rigid nature of conventional resource bundles can make it difficult for organizations to dynamically adjust resources in real-time, forcing them to either overcompensate or risk underperformance, both of which can impact the overall efficiency and effectiveness of their cloud strategy.

Another significant challenge with conventional approaches to resource bundle provisioning is the constantly evolving compute landscape. Cloud service platforms and providers frequently release new VMs, resources, and configurations that offer improved performance, cost-efficiency, or specialized capabilities. As these new options become available, organizations relying on static resource bundles may find it difficult to adapt quickly. The predefined nature of conventional resource bundles means that they may not immediately incorporate the latest advancements, leading to potential missed opportunities for optimization. This lag can result in organizations using outdated or less efficient resources, which could hinder their ability to stay competitive or meet emerging service demands. Additionally, the rapid pace of innovation in cloud computing can make it challenging for organizations to continuously reassess and update their resource provisioning strategies, creating a gap between what is available and what is actually being utilized.

An organization's failure to appreciate a provisioned resource bundle's utilization, as well as adapt to updates or advancements within resource bundles can impact both the performance and cost-efficiency of an organization's cloud operations. Over-provisioning, where more resources are allocated than necessary, leads to wasted capacity and inflated costs, as businesses pay for resources that go unused. Under-provisioning, on the other hand, can result in performance degradation, slower response times, and even service outages, as the allocated resources fail to meet the actual demands of the application or service. Additionally, the inability to quickly adopt the most advanced and efficient resources or configurations due to rigid bundling practices further exacerbates these issues. As new, more powerful, or cost-effective VMs and configurations are introduced by cloud providers, organizations stuck with outdated resource bundles may miss out on the benefits of these advancements. This not only leads to suboptimal performance and higher costs but also puts organizations at a competitive disadvantage, as they are unable to leverage the latest technologies to enhance their services and operational efficiency.

To address at least the shortcomings discussed above, an example compute engine is provided herein. In particular, a compute engine is provided that responds to both the changing service demands and the rapidly evolving cloud technology landscape. As will be described in greater detail below, the compute engine may identify and recommend a compute configuration based on the current resource landscape and tailored to a respective service. As used herein, the term compute configuration refers to the specific arrangement of both hardware resources—such as CPU, memory, storage, and networking—and, in some cases, the software components, including the operating system, middleware, and software libraries, that are selected to support a particular application or service.

To determine a compute configuration that provides efficient resource provisioning for the service, the compute engine may determine a utilization of current computing resources (hereinafter “current resources”) consumed by the service. The utilization may evaluate both the operational efficiency of the current resources as well as a demand efficiency of the current resources. That is, the compute engine may determine how efficiently the current resources are handling the workload requirements of the services and how efficiently the current resources are estimated to handle a forecasted demand in the future.

Based on the utilization of the current resources, which may be part of a resource bundle, the compute engine may analyze the current resource landscape to identify whether there are more efficient compute configurations for the service. In an example, the current resource landscape may be a compute catalog provided by a service platform or provider that offers the most up-to-date resource bundles, configurations, and virtual machine options. Based on the service's utilization of the current resources and the current resource landscape, the compute engine may select the latest and most efficient resources for the service's specific workloads and operational needs. In some cases, the compute engine may analyze the current resource landscape based on one or more provisioning policies governing the services. For example, the service may require specific security measures, such as encryption requirements, or have regional limitations for the resources. Based on these provisioning policies, as well as the service utilization, the compute engine may identify a compute configuration that provides more efficient resource provisioning than the current resources.

As used herein, “more efficient resource provisioning” refers to the ability to allocate computing resources—such as CPU, memory, and storage—in a way that minimizes waste and maximizes the performance of services. In other words, the compute engine may recommend a resource bundle that assigns just the right amount of resources needed to meet current demand without over-allocating and incurring unnecessary costs, or under-allocating and risking poor service performance. As will be described in greater detail below, efficient resource provisioning may involve accurately matching resource capacity with workload requirements, reducing idle time for unused resources, and ensuring consistent service delivery with minimal interruptions. Efficiency in this context also includes minimizing energy consumption and infrastructure costs by avoiding the deployment of excess hardware or resources that are not actively contributing to service output.

By identifying the most efficient compute configuration for a service, the compute engine provides several advantages over conventional approaches, particularly in terms of performance, cost savings, and scalability. By selecting the most up-to-date software and VM configurations, the compute engine ensures that a respective service runs on an optimized infrastructure, allowing for faster processing speeds, lower latency, and more reliable service delivery. As noted above, cloud-based technologies are constantly evolving, meaning constant enhancements such as better resource utilization, improved security features, and greater compatibility with cutting-edge technologies. By periodically analyzing the current resource landscape for more efficient compute configurations, the compute engine can provide a smoother and more efficient operation of a respective service. Additionally, by identifying the latest compute configurations, the compute engine allows organizations to minimize their resource footprint, reducing both operational costs and the risk of over-provisioning unnecessary capacity. The compute engine also minimizes resource waste and energy use, helping organizations reduce the carbon footprint tied to their cloud operations. Ultimately, by identifying the most efficient compute configuration for a respective service, the compute engine allows organizations to provide a high-performing, consistent service to consumers while keeping costs, waste, and environmental impact to a minimum.

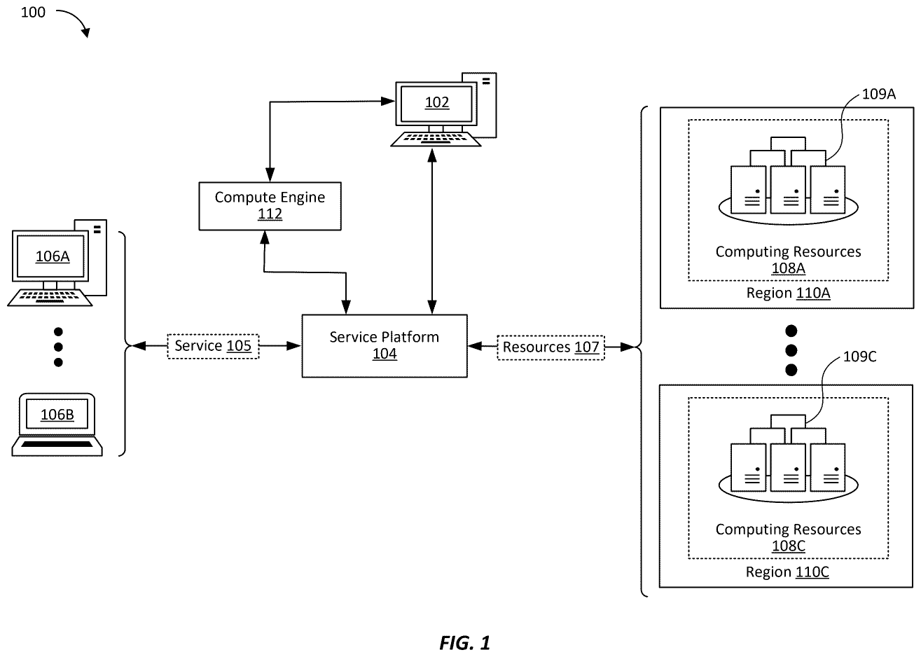

Turning now to the Figures, FIG. 1 illustrates an example operational environment of a system 100 in which a client device 102 provides a service 105 to client devices 106A-C, according to an embodiment herein. The client device 102, which may be associated with an organization or business, may interact with a service platform 104 to provide the service 105 to the client devices 106A-C, which may correspond to end-users or consumers of the service 105. The service 105 may be or include a range of services, such as a web-based application or a software-as-a-service (SaaS) product, delivered through the service platform 104. The service platform 104 acts as the intermediary that hosts and manages the infrastructure required to run the service 105, ensuring it is accessible to the client devices 106A-C over the internet or a network.

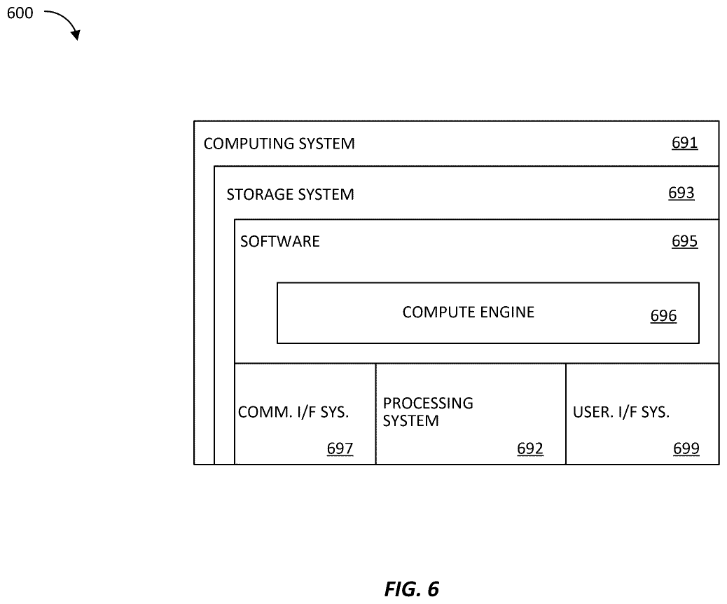

Broadly speaking, the client devices 102 and 106A-C may include personal computers, tablet computers, mobile phones, gaming consoles, wearable devices, Internet of Things (IoT) devices, and any other suitable devices, of which computing apparatus 600 in FIG. 6 is also broadly representative. As such, the client devices 102 and 106A-C may communicate with the service platform 104 via one or more networks, including the Internet, intranets, wired and wireless networks, local area networks (LANs), wide area networks (WANs), or any combination thereof. In particular, the client devices 106A-C may interact with the service 105 (e.g., a web-based application) through network requests, accessing and utilizing the service's functionality via application programming interfaces (APIs) or user interfaces provided by the service platform 104. Similarly, the client device 102 may interact with the service platform 104 to deploy and manage the service 105 by configuring resources, setting operational parameters, monitoring performance, and scaling the service as needed to meet consumer demand.

As illustrated, the service 105 may be provided within a cloud-based or hybrid environment, where the service platform 104 manages the provisioning of resources 107 to support its operation. These resources 107, which can include virtual machines, storage, processing power, and networking, may be allocated by the service platform 104 to ensure the seamless delivery of the service 105 to client devices 106A-C. The resources 107 may be provisioned from a pool of resources 108A-C, which represent various types of computing assets such as virtual machines, storage, and network bandwidth. The resources 108A-C may be hosted on physical servers 109A-C that are distributed across different regions 110A-C or locations around the globe. The distribution of resources 108A-C across multiple regions 110A-C allows for greater flexibility and redundancy, enabling the service platform 104 to allocate resources 108A-C based on proximity to the end-users, reducing latency and improving performance.

One or more of the resources 108A-C may have differing security limitations, such as varying encryption features or compliance certifications, ensuring that specific security requirements for the service 105 can be met based on geographic or regulatory constraints. The geographic diversity of resources 108A-C and their associated security configurations may allow the service platform 104 to deliver the service 105 with high availability, security, and performance tailored to the needs of different users and regions. It should be appreciated that while only three regions 110A-C and pools of computing resources 108A-C are illustrated, there may be any number of regions 110A-C and/or groups of computing resources 108A-C. For ease of illustration, the number of regions 110A-C and computing resources 108A-C is limited.

As noted above, the resources 108A-C are generally hosted on one or more servers 109A-C, respectively, which serve as the physical infrastructure that powers the provisioned computing services and applications, such as the service 105. As those skilled in the art readily appreciate, the servers 109A-C are specialized computers designed to handle processing, storage, and networking tasks efficiently. Typically, the servers 109A-C consist of CPUs (Central Processing Units), ample amounts of RAM (Random Access Memory), and storage devices such as hard disk drives (HDDs) or solid-state drives (SSDs). In data centers or cloud environments, servers 109A-C are organized into clusters or racks, interconnected through high-speed networks to enable communication and resource sharing. Virtualization technologies further optimize server utilization by allowing multiple virtual machines, instances, or containers to run on a single physical server, maximizing resource efficiency.

In some embodiments, the service platform 104 may include a cloud provider that hosts or offers the cloud infrastructure, including the resources 108A-C. The cloud provider supplies the foundational infrastructure, such as the services 109A-C, data centers (not shown), and networking capabilities, upon which the service platform 104 operates. This infrastructure includes the resources 108A-C used to form the VMs, storage, and processing power leveraged to support services like service 105. By leveraging the cloud provider's infrastructure, the service platform 104 can efficiently allocate and manage resources 108A-C, ensuring that the necessary computing power and storage are available to meet the demands of the client devices 106A-C. As will be described below, the cloud provider may also continuously update and maintain the underlying hardware and software, releasing new versions of VMs, security enhancements, and performance optimizations, allowing the service platform 104 to deliver high-quality, scalable services while reducing the burden of infrastructure management on the organization.

In some embodiments, the service platform 104 may provision the resources 107 as part of a resource bundle, which is a predefined package of computing resources designed to meet specific performance and operational requirements of the service 105. A resource bundle typically includes a set allocation of virtual machines, storage, processing power, and networking capabilities that are provisioned together from the resources 108A-C to support the service 105. By using resource bundles, the service platform 104 can streamline the provisioning process, ensuring that the necessary resources are allocated efficiently and in a consistent manner. These bundles are often optimized for specific types of workloads, such as web applications or data processing services, allowing the organization, such as via the client device 102, to select the most appropriate configuration for the service 105. Additionally, resource bundles may simplify cost management and performance monitoring, as the resources 107 within the bundle are packaged and billed together.

In an example, the resource bundle may be a Stock Keeping Unit (SKU), which is a predefined package of resources 107 tailored to a specific type of workload. For instance, a SKU may be designed to support a high-traffic web application and could include a set number of VMs with a fixed amount of CPU cores, memory, storage, and network bandwidth. This SKU might also come with specific performance guarantees, such as a certain level of uptime or response time, to ensure the service 105 meets the demands of its users (e.g., client devices 106A-C). Additionally, SKUs may offer advanced features, such as automatic scaling or enhanced security configurations like encryption and firewall settings, depending on the nature of the service 105 being provided. By selecting a SKU, the service platform 104 can quickly provision the necessary resources 107 in a standardized manner, ensuring that the service 105 operates within the predefined parameters set by the client device 102 (e.g., organization). As can be appreciated, SKUs make it easier for organizations to manage resources 107 without needing to manually configure each component, while also benefiting from the predictability and simplicity of a bundled resource approach.

When the resources 107 are provisioned as part of a resource bundle, the risk of over-or under-provisioning for the service 105 increases. Over-provisioning occurs when more computing resources 107—such as CPU, memory, or storage—are allocated than the service 105 actually requires, leading to inefficiencies and higher operational costs. For instance, if demand from the client devices 106A-C decreases but the resource 107 provisioned for the service 105 remains fixed at a higher capacity, the excess resources are wasted. On the other hand, under-provisioning happens when the resources 107 do not provide enough capacity to meet the needs of service 105, especially during unexpected spikes in demand from the client devices 106A-C. In such cases, the service 105 may experience slowdowns or outages, unable to handle the increased workload. This mismatch can also occur in other scenarios, such as when new features are introduced or usage patterns change, causing the current resource 107 to no longer align with the actual needs of the service 105.

As noted above, cloud-based technologies are continuously evolving. As such, the resources 108A-C may continually evolve as cloud-based technologies advance, with the regular release of new VMs and software configurations that provide improved performance, efficiency, and security features for the service 105. As cloud providers innovate, they frequently introduce updated versions of VMs that are equipped with more powerful processors, expanded memory capacities, and enhanced networking capabilities. These new releases allow organizations to take advantage of the latest advancements in computing, ensuring that their services remain competitive and optimized for modern workloads. Additionally, software configurations are also continually updated to offer better scalability, more robust security protocols, such as advanced encryption standards, and increased compatibility with emerging technologies like artificial intelligence and machine learning. The evolving nature of resources 108A-C ensures that the service platform 104 can provision resources that align with the latest industry standards, providing end-users with a seamless and high-performing experience while enabling businesses to future-proof their cloud infrastructure.

Due to the fast-paced nature of this evolution, organizations and businesses often struggle to keep up with the frequent updates to cloud resources. This often leads to inefficiencies in provisioning the most suitable compute configurations for services like service 105. This challenge is often more pronounced when the resources 107 are provisioned as part of a resource bundle. When the resources 107 are provisioned as part of a resource bundle, organizations may continue to rely on outdated resource bundles that no longer reflect the latest advancements, resulting in over-provisioning or under-provisioning. This failure to adapt can lead to unnecessary costs, wasted computing power, or degraded service performance, as the resources in the bundle may not align with the current needs of the service 105. Staying current with the evolving resource landscape is critical for businesses to ensure that they are leveraging the most efficient configurations to deliver high-quality, cost-effective services to end-users (e.g., 106A-C).

Organizations and businesses may struggle to keep up with the frequent updates to cloud resources 108A-C, particularly when relying on resource bundling, because they may not fully understand the technical advancements or how these updates apply to their specific service, like service 105. Although cloud providers frequently release new VMs, storage solutions, and software configurations with enhanced capabilities, organizations often find it difficult to evaluate how these improvements impact their particular workloads. Without in-depth knowledge of how the latest updates can optimize service 105, businesses may continue using outdated resource bundles, unaware of the potential benefits of switching to more efficient configurations. This knowledge gap can lead to missed opportunities for improving performance, reducing costs, or enhancing security, as the organization struggles to translate evolving technologies into practical improvements for their cloud services, like the service 105.

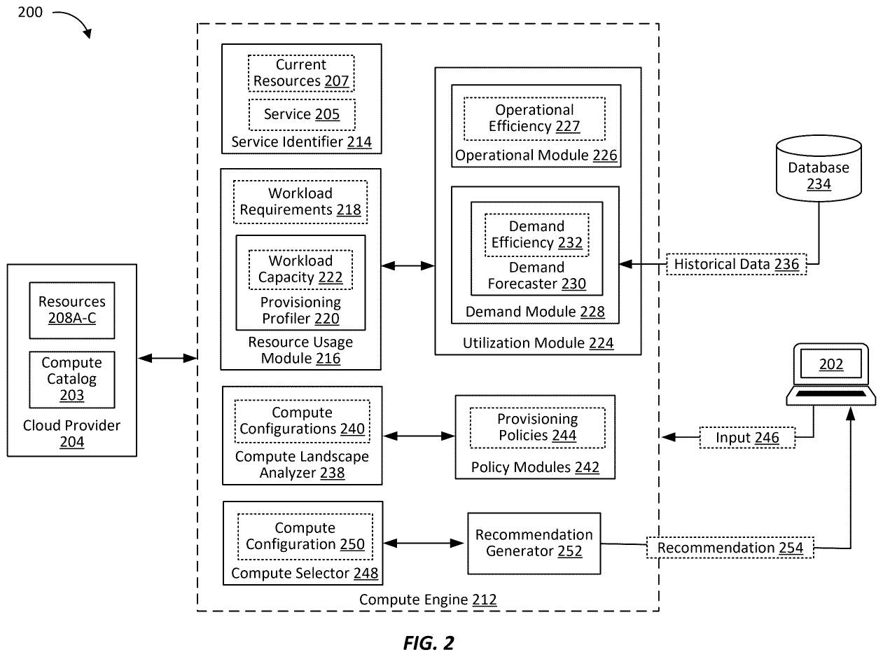

To aid the client device 102, and the respective organization, with identifying more efficient resources for the service 105, the system 100 may include a compute engine 112. The compute engine 112 may be in operational communication with the service platform 104 such to determine a current utilization of the resources 107 by the service 105. As will be described in greater detail below with respect to FIGS. 2-5, the utilization of the resources 107 may indicate whether the resources 107 are over-provisioned or under-provisioned for the service 105, both based on the current operational requirements and the forecasted operational requirements of the service 105. Based on the utilization of the resources 107, the compute engine 112 may communicate with the service platform 104 and/or the cloud provider offering the compute resources 108A-C to determine a current compute landscape. The current compute landscape may identify the diverse range of resources that are currently offered by the cloud provider, including the latest configurations or advancements made to respective resources both in a hardware capacity and a software capacity.

By analyzing the current resource landscape in view of the service's 105 utilization of the resources 107, the compute engine 112 may identify a compute configuration that is more efficient than the resources 107. As noted above, the compute configuration may be more efficient than the resources 107 because it provides resources tailored to the specific workload and operational requirements of the service 105 without over-or under-provisioning resources and providing a cost-efficient option to the organization without impacting the performance of the service 105.

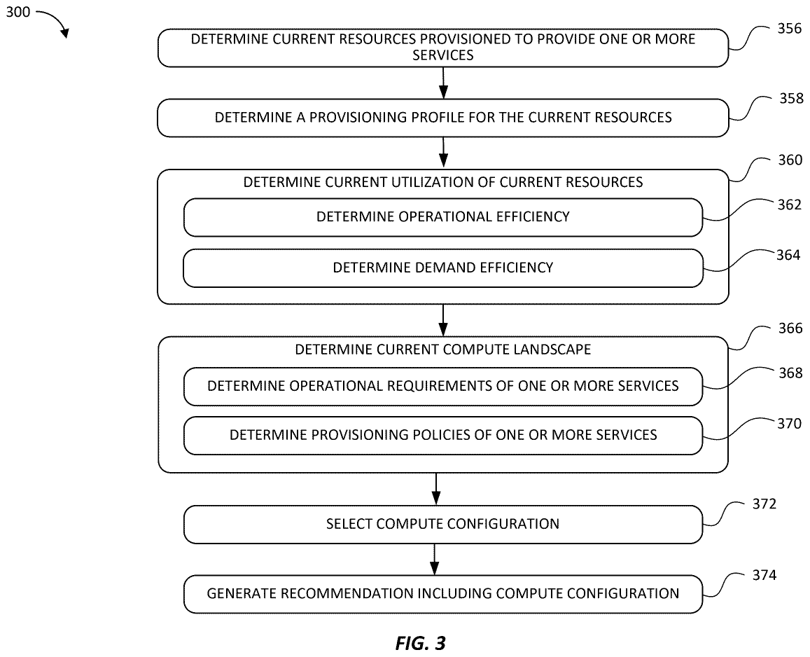

Referring now to FIG. 2, an example system 200 in which a compute engine 212 is leveraged to identify compute configurations tailored to a service 205, is illustrated, according to an embodiment herein. For ease of explanation, FIG. 2 is described with reference to FIG. 3, which illustrates a process 300 for providing a compute engine and one or more of its functions, according to an embodiment herein. Although FIG. 3 is described in relation to FIG. 2, it should be appreciated that the process 300 is equally applicable to the remaining figures and components therein.

The compute engine 212 may be in operational communication with a client device 202, which may be the same or similar to the compute engine 112 and the client device 102, respectively. The client device 202 may correspond to an organization or business that provides the service 205, which may be the same or similar to the service 105, to end-users or consumers within a cloud-based or hybrid environment. As such, the client device 202 may interact with a cloud provider 204 to provision one or more resources 208A-C, such as the resources 207 to support the service 205. The cloud provider 204 may be part of or in operational communication with the service platform 104 such to provision and allocate resources 208A-C as required to support the service 205. The resources 208A-C may be the same or similar to the resources 108A-C described above.

In the illustrated example, the cloud provider 204 may provision current resources 207 to support the service 205 on behalf of the client device 202. The current resources 207, which may be the same or similar to the resources 107 may be provisioned as part of a resource bundle. For example, the current resources 207 may be a SKU provided by the cloud provider 204. In such cases, the current resources 207 may be a predefined package or unit of resources, such as CPU, memory, storage, and networking that is provisioned from the cloud provider 204 for the service 205. As such, as the workload demands of the service fluctuates, the current resources 207 may no longer be appropriate or sufficient to support the service 205, both from the perspective of resource provisioning and latest enhancements but also cost.

To address at least these scenarios, the compute engine 212 may periodically assess a service's 205 performance and whether or not the provisioned resources 207 are adequate in view of the most current resource landscape. For a respective service, the compute engine 212 may determine the current resources 207 that are provisioned to provide the service 205 (356). In particular, the compute engine 212 may include a service identifier 214 that may identify the service 205 as associated with the client device 202, such as based on a user profile of the client device 202, and then identify the current resources 207 as provisioned for the service 205. It should be appreciated that while the following discussion focuses on a single service, in some embodiments there may be more than one service.

Once the current resources 207 are identified, the compute engine 212 may determine a provisioning profile for the resources 207 (358). In particular, the compute engine 212 may include a resource usage module 216 that may include a provisioning profiler 220 that may determine the provisioning profile of the current resources 207. The provisioning profile may include the hardware specifications and/or the software specifications of the current resources 207. For example, if the current resources 207 consist of VMs, the provisioning profile may describe the VMs' hardware characteristics, such as the number of CPU cores, available memory, storage capacity, and network bandwidth. The provisioning profile may also outline the software configurations, such as the operating system, software libraries, and any pre-installed applications or middleware that are required to run the service 205 efficiently. Based on the provisioning profile, the resource usage module 216 may determine a workload capacity 222 of the current resources 207.

In some embodiments, the provisioning profiler 220 may determine the hardware and software specifications associated with the resources 207 by querying the cloud provider 204. For example, based on the current resources 207, the provisioning profiler 220 may query or perform a look-up within a compute catalog 203 provided by the cloud provider 204. In the example where the current resources 207 are a SKU, then the provisioning profiler 220 may extract information from the compute catalog 203 such as compute SKU item family and version. Based on such information, the provisioning profiler 220 may determine the hardware and software specifications of the current resources 207.

Responsive to identifying the current resources 207 and determining a respective provisioning profile, the compute engine 212 may determine a utilization of the current resources 207 by the service 205 (360). In particular, the compute engine 212 may include a utilization module 224 that determines the utilization for the current resources 207. To determine the utilization of the current resources 207 by the service 205, the utilization module 224 may determine an operational efficiency 227 of the resources 207 (362) and/or determine a demand efficiency 232 of the resources 207 (364). As illustrated, the compute engine 212 may include an operational module 226 that determines the operational efficiency 227 and a demand forecaster 230 that determines the demand efficiency 232 for the resources 207. The operational efficiency 227 and the demand efficiency 232 are described in greater detail below.

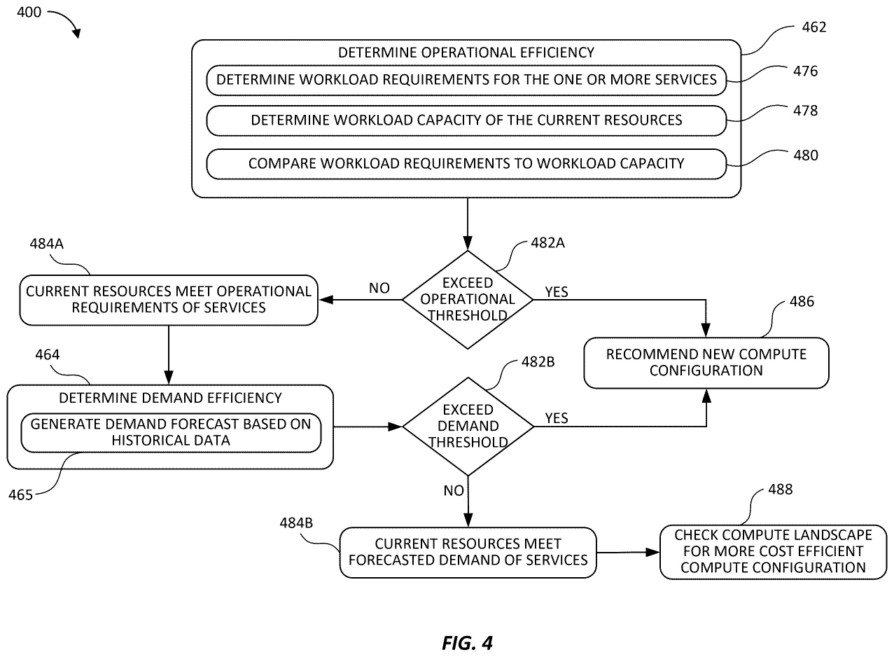

To determine the operational efficiency 227 of the resources 207 (362), the compute engine 212, such as via the resource usage module 216, may determine workload requirements 218 of the services 205 and determine the workload capacity 222 of the current resources 207. Then, the compute engine 212 may compare the workload requirements 218 to the workload capacity 222 to determine the operational efficiency 227. In other words, the operational efficiency 227 may refer to how effectively the current resources 207 are utilized in relation to the needs (e.g., operational requirements 218) of the service 205 they support. That is, the operational efficiency 227 may indicate the resource utilization of the service 205. As will be described in greater detail below with respect to FIG. 4, in some embodiments the operational efficiency 227, in particular the resource utilization, may be compared to an operational threshold to determine whether or not the current resources 207 are over-provisioned or under-provisioned based on the workload requirements 218 of the service 205.

As noted above, the operational efficiency 227 may include a resource utilization of the current resources 207 by the service 205. The resource utilization may include one or more of CPU utilization, memory utilization, storage utilization, and/or network utilization of the current resources 207 by the service 205. The CPU (and processing power) utilization may refer to how the current resources 207 handle the computational demands outlined by the workload requirements 218 of the service 205. For example, if the service 205 requires high-speed calculations or supports numerous simultaneous users, the utilization of CPU resources must align with these needs. If the workload capacity 222 of the resources 207 provides more CPU power than necessary, the utilization is inefficient, leading to resource waste. Conversely, under-provisioning results in poor CPU utilization, causing slow performance or service interruptions.

Memory (RAM) utilization may reflect how well the available memory resources are used to support the service 205's operations. If the workload requirements 218 include large datasets or real-time processing, the service 205 may require adequate memory to function smoothly. As such, the workload capacity 222 of the resources 207 must provide enough RAM to meet these requirements without excess or shortage.

Storage utilization may indicate how the storage resources 207 meet the data handling and storage needs of the service 205. The workload requirements 218 may dictate how much data needs to be stored and how quickly it must be accessed, such as in media-heavy services. Effective storage utilization may be identified when the workload capacity 222 provides just enough storage and the right technology (like SSDs for speed or HDDs for capacity) to match the service's 205 needs.

And in scenarios where the service 205 involves data transfers, such as streaming or cloud-based file access, network bandwidth utilization may be a key indicator of efficient resource usage. For example, the workload requirements 218 may describe the amount of data that needs to flow between the service 205 and its users, and the workload capacity 222 must ensure the resources 207 provide sufficient bandwidth. Efficient network utilization may be when the bandwidth is enough to handle peak traffic without overwhelming the network, while under-utilization may suggest over-provisioning, and over-utilization can result in connection issues or service lags.

In some embodiments, the workload requirements 218 may be part of the operational requirements of the service 205. The operational requirements may include a buffer capacity that the service 205 requires. For example, for certain services, such as a user authentication service, the service 205 may require a buffer capacity of more than 50 percent of the workload capacity 222 for the current resources 207. In other words, the workload requirements 218 may require that the service 205 only utilize the 50 percent or less of the workload capacity 222 of the resources 207, thus having a buffer capacity of at least 50 percent. Follow the user authentication service example, the buffer capacity may be a safety or back-up mechanism that ensures that the service 205 can accommodate scenarios in which there is a large influx of demand, such as if a large portion of users attempts to sign-in at the same time. Other examples of operational requirements include storage and memory capacity, network bandwidth, provisioning policies (e.g., security features), and the like.

In some embodiments the operational requirements of the service 205 may be provided by the client device 202, such as upon creation and/or deployment of the service 205, via an input 246. As will be described below, the input 246 may also include one or more provisioning policies 244 for the service 205 provided by the client device 202. In other embodiments, the compute engine 212 may determine the operational requirements of the service 205. For example, the compute engine 212 may include one or more machine learning (ML) or artificial intelligence (AI) models that determine one or more operational requirements based on historical data 236 of the service 205. For example, the resource usage module 216 may determine the service 205 requires a capacity buffer of more than 60 percent during a certain time of the year, such as the holidays, based on historical data 236.

The historical data 236 may be a data set that includes the workload requirements 218 of the service 205 of a previous period of time, such as the past 6 months, past year, etc. In some embodiments, the historical data 236 may also include the workload capacity 222, the operational efficiency 227, and/or the demand efficiency 232 of the service 205 over a given time period. As such, the compute engine 212 may leverage the historical data 236 to determine various patterns that may be present in the service's 205 utilization and workload, such as determining a capacity buffer is required for the service 205 during a certain period of time during the year. As illustrated, in some embodiments, the historical data 236 may be stored in a database 234. While the database 234 is illustrated as separate from the compute engine 212, the database 234 may be part of the compute engine 212, may be hosted by the same entity that hosts the compute engine 212, or may be hosted by a third party.

The historical data 236 may also be used to determine the demand efficiency 232 of the service 205. Demand efficiency 232 may refer to how well the provisioned resources 207 are positioned to meet the forecasted demands of the service 205. To determine the demand efficiency 232 the demand module 228 may include a demand forecaster 230. The demand forecaster 230 may determine the demand efficiency 232 based on the historical data 236. In particular, the demand forecaster 230 may generate a demand forecast that predicts the workload requirements of the service 205 at a future time. For example, the demand forecaster 230 may determine the demand forecast of the workload requirements of the service 205 for one month in the future based on the past 6-months of historical data 236. In some embodiments, the demand forecaster 230 may be or include one or more ML or AI models that identify patterns within the historical data 236 to determine the demand forecast for the service 205.

From the historical data 236, the demand forecaster 230 may predict the service's 205 future needs based on expected user behavior, traffic patterns, or other operational factors, thereby ensuring that the resources 207 provisioned in the future are sufficient to handle the predicted workload of the service 205. For example, the demand forecaster 230 may predict the service's workload requirements at a future date based on the service's current usage (e.g., utilization), as well as other external factors, such as seasonality. In an example, the demand forecaster 230 may predict the service's CPU utilization and memory utilization over the next 6 months based on the current resources and then determine what the demand efficiency 232 is based on these predicted workload requirements. By determining the demand efficiency 232, the compute engine 212 may ensure that the provisioned resources 207 accommodate the workload of the service 205 as it evolves over time.

Simultaneously or sequentially to determining the utilization of the current resources 207, the compute engine 212 may determine a current compute landscape (366). The current compute landscape may include supply data for one or more compute configurations, such as resource bundles currently offered by the cloud provider 204. That is, the compute engine 212 may determine what compute configurations are currently offered via the cloud provider 204. It should be appreciated that while the current example refers to a single cloud provider 204, in some embodiments, the compute engine 212 may determine the current compute landscape from more than one cloud provider 204.

To determine the current compute landscape, the compute engine 212 may query the compute catalog 203 provided by the cloud provider 204. In some cases, the compute engine 212 may include a compute landscape analyzer 238 that queries the compute catalog 203 to determine available resources 208A-C. As part of its query, the compute landscape analyzer 238 may identify one or more compute configurations 240 that meet the operational requirements and/or the provisioning policies 244 of the service 205. As such, the compute engine 212 may first determine the operational requirements of the service 205 (368), and in some embodiments, any governing provisioning policies 244 for the service 205 (370) to accurately identify the current compute landscape. As noted above, the operational requirements and/or the provisioning policies 244 may be provided as an input 246 from the client device 202. While the operational requirements for the service 205 correspond to the specific computing requirements for the service 205 (e.g., processing power), the provisioning policies 244 may correspond to other governing factors that may impact resource provisioning by the compute engine 212.

In some embodiments, the provisioning policies 244 may include security requirements or policies for the service 205. That is the provisioning policies 244 may include security requirements that govern or impact what resources can be provisioned to support the service 205. Example security requirements may include data encryption requirements, which ensure that sensitive information is protected both at rest and in transit, access control mechanisms, such as multi-factor authentication (MFA) and role-based access controls (RBAC), and location restrictions on where hardware of the respective resources 207 can be located. Additional provisioning policies 244 that may impact what resources can be provisioned for the service 205 include any industry standard compliance regulations or policies that may apply to the service 205, such as GDPR or HIPPA, backup and recovery protocols, and firewall or intrusion detection systems (IDS). Each of these security requirements may limit what resources can be provisioned for the service 205, such as by restricting the use of certain resources to regions or data centers that adhere to regional compliance requirements, or limit the pool of available resources 208A-C to resources that support the security features necessary to meet the security requirement (e.g., encryption requirements).

When the compute landscape analyzer 238 queries the compute catalog 203, the compute landscape analyzer 238 may initially identify the resources 208A-C that are available and in a healthy state. In an embodiment, the compute landscape analyzer 238 may determine the sustainability of a respective compute configuration to ensure that if selected the compute configuration is healthy and available. The sustainability of a compute configuration may include whether the compute configuration is in short supply, the depreciation path of the compute configuration, and other availability considerations. For example, if the compute configuration is known to be in short supply, then the compute landscape analyzer 238 may not recommend the compute configuration to avoid issues during migration and minimize churn. Similarly, the compute landscape analyzer 238 may not select a compute configuration having a depreciation path or a compute configuration that has limited availability.

The compute landscape analyzer 238 may then filter these resources 208A-C to identify the compute configurations 240 that meet the specific operational configuration required for the service 205 (e.g., CPU, memory). This may include identifying compute configurations 240 based on the current utilization of the resources 207, such as based on the workload requirements 218 of the service 205. In some embodiments, identification of the compute configurations 240 may be based on the operational efficiency 227 of the resources 207 and/or the demand efficiency 232 of the resources 207. For example, the compute landscape analyzer 238 may determine how over-or under-provisioned the resources 207 are for handling the service 205 (e.g., operational efficiency 227) and whether the resources 207 will be able to handle the predicted demand forecast for the service 205 (e.g., demand efficiency 232).

In some embodiments, once the compute configurations 240 are identified, the compute landscape analyzer 238 may filter the compute configurations 240 based on the provisioning policies 244. For example, once the compute configurations 240 are identified that meet the operational requirements of the service 205, the compute landscape analyzer 238 may filter the compute configurations 240 to identify the subset of compute configurations 240 that meet the provisioning policies 244 of the service 205 (e.g., security requirements).

In some cases, the compute landscape analyzer 238 may use the provisioning policies 244 to identify the compute configurations 240 and then filter the compute configurations 240 to identify a subset that provides a more cost effective option. For example, if there is a subset of the compute configurations 240 that meet the operational requirements and the provisioning policies 244 of the service 205, the compute landscape analyzer 238 may then filter the compute configurations 240 to identify one or more compute configurations 240 that have the lowest cost.

Since the compute catalog 203 offered by the cloud provider 204 lists the resources 208A-C that are currently available for provisioning, it is likely that the included resources 208A-C represent the most recent updates and advancements in cloud technology. The compute catalog 203 typically features the latest VMs, storage solutions, networking options, and software configurations, ensuring that users can access the most up-to-date offerings. These resources 208A-C often come with enhanced performance capabilities, security features, and optimized software configurations, allowing organizations to take advantage of the latest innovations in computing. By relying on the compute catalog 203 to determine the current resource landscape, the compute engine 212 can ensure that the resources 208A-C that form the compute configurations 240 provide the latest and most efficient technology.

From the compute configurations 240 (or the subset of compute configurations 240), the compute engine 212 may select a compute configuration 250 (372). In particular, the compute engine 212 may include a compute selector 248 that selects the compute configuration 250. The compute configuration 250 may be selected from the compute configurations 240 as being the most efficient compute configuration. For example, if the top three compute configurations 240, which may each be a resource bundle, each meet the operational requirements and the provisioning policies 244 of the service 205, but two of these compute configurations provide more resources than required by the service 205 (e.g., more CPUs or storage than required), then the compute selector 248 may select the third compute configuration as the compute configuration 250 that provides resources that align closest to the operational requirements of the service 205. In other words, the compute selector 248 selects the compute configuration 250 from the compute configurations 240 that is tailored to the service 205.

In embodiments where the computing configurations 240 are all the same when it comes to computing arrangement aligning with the operational requirements of the service 205, the compute selector 248 may select the compute configuration 250 that has the lowest cost. In other words, if all of the computing configurations 240 identified by the compute landscape analyzer 238 meet the operational requirements and provisioning policies 244, and each provide a computing arrangement (e.g., the configuration and allocation of computing resources—such as CPU, memory, storage, and networking) that is substantially similar to the service's 205 requirements (e.g., one configuration may provide slightly more CPU, while another configuration may provide slightly more memory), the compute selector 248 may then select the compute configuration 250 having the lowest cost since all other features of the configurations 240 are substantially similar.

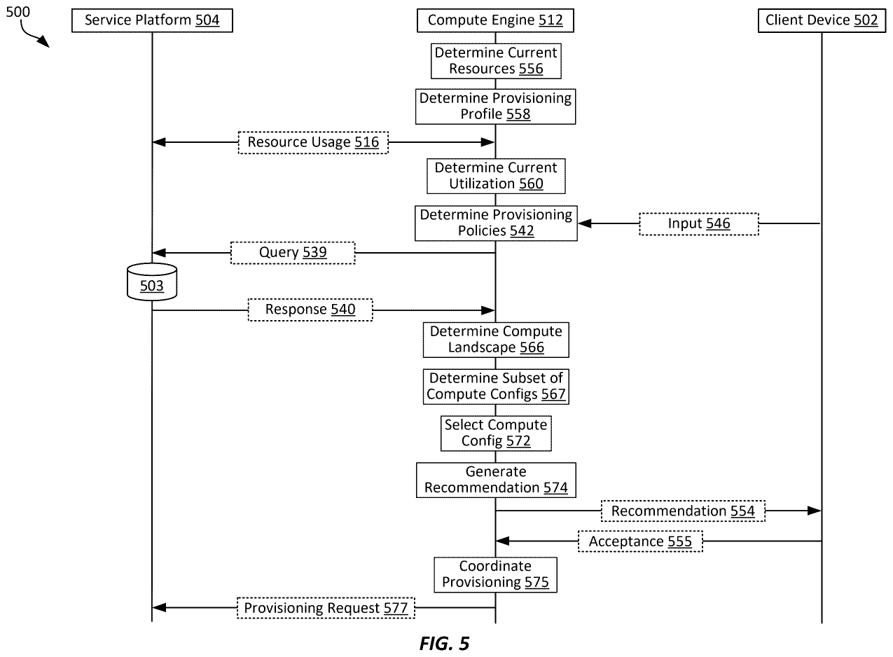

Once the compute configuration 250 is identified, the compute engine 212 may generate a recommendation including the compute configuration 250 (374). In particular, the compute engine 212 may include a recommendation generator 252 that generates a recommendation 254. The recommendation 254 may include a recommendation that the organization switch from the current resources 207 to the compute configuration 250. Once generated, the compute engine 212 may provide the recommendation 254 to the client device 202. As will be described in greater detail below with respect to FIG. 5, in some embodiments, responsive to receiving the recommendation 254, the client device 202 may accept the recommendation 254 of switching to the compute configuration 250 and the compute engine 212 may coordinate the request with the cloud provider 204.

As noted above, the compute engine 212 may perform the above described analysis on a periodic basis. That is, once per a time period (e.g., once a month, once every 6 months), the compute engine 212 may perform one or more of the above described process to identify the compute configuration 250 that may be better suited and tailored to the service's 205 needs. As can be appreciated, services, in particular those hosted in cloud-based environments, often have fluctuating demands that may change the underlying requirements for resources. As such, for organizations relying on resource bundles, periodically checking the current compute landscape in view of the service's 205 changing needs can ensure the provisioned resources not only provide the latest technological enhancements, but also are tailored to the service's 205 current and future needs.

Referring now to FIG. 4, an example process 400 for providing one or more functions of a compute engine is illustrated, according to an embodiment herein. In particular, the process 400 illustrates a decision flow that a compute engine, such as the compute engine 212 may make to determine whether or not to recommend a new compute configuration, such as the compute configuration 250. For ease of illustration, FIG. 4 is describe in relation to FIG. 2. As can be appreciated, there may be scenarios where the currently provisioned resources, such as the current resources 207, are sufficiently sourced such that they meet the operational requirements of the service 205. However, the compute engine 212 may still identify the compute configuration 250 that is more efficient for the service 205, such the compute configuration 250 is more cost efficient than the current resources 207 and/or better suited to meet the service's 205 predicted demands.

As shown, the process 400 may start with the compute engine 212 determining the operational efficiency 227 of the current resources 207 (462). Determining the operational efficiency 227 of the current resources 207 may include determining the workload requirements of the service 205 (476) and determining the workload capacity of the current resources 207 (478), as described above. In some cases, the compute engine 212 may compare the workload requirement to the workload capacity (480) to determine a ratio. This ratio may be one metric that the compute engine 212 can use to determine the utilization of the resources 207. For example, a ratio of the workload requirement to the workload capacity may indicate that the service 205 is utilizing a specific percentage (e.g., 20%, 30%, 40%, 50%, 60%, 70%, 80%, or above) of the current resources 207. In some embodiments, this ratio may be computed as part of the operational efficiency 227 of the resources 207. In still another embodiment, this ratio may be computed on a per component/resource basis within the current resources 207. For example, the compute engine 212 may determine a CPU ratio, a memory ratio, a network bandwidth ratio, and the like.

In some embodiments, the operational efficiency 227, which may include the ratio, may be compared to an operational threshold (482A). The operational threshold may be a threshold which indicates whether the current resources 207 are over-provisioned or under-provisioned for the service 205. It should be appreciated that while the following discussion focuses on the operational efficiency 227 exceeding the operational threshold, in some embodiments there may be an operational range to which the operational efficiency 227 is compared. If the operational efficiency 227 falls outside of the range, then the current resources 207 may be considered to be either over-or under-provisioned for the service 205. In another embodiment, there may be a second operational threshold to which the operational efficiency 227 is compared. Falling below the second operational threshold may indicate that the current resources 207 is over-or under-provisioned, depending on the scenario.

Here, for ease of explanation, it is assumed that if operational efficiency 227 exceeds the operational threshold, the current resources 207 are over-provisioned for the service 205. As such, if, based on the comparison, the compute engine 212 determines that the operational efficiency 227 of the current resources 207 exceed the operational threshold, then the compute engine 212 may recommend a new compute configuration (486). That is, in some embodiments, if the operational threshold is exceeded, the compute engine 212 may continue onto the determine the current compute landscape to identify compute configurations 240 that may be better tailored to the operational requirements of the service 205 than the current resources 207.

If the operational efficiency does not exceed the operational threshold, then the compute engine may determine that the current resources 207 meet the operational requirements of the services 205 (484A). In such cases, the compute engine 212 may then determine the demand efficiency 232 of the current resources 207. As described above, this may include generating a demand forecast based on the historical data of the service 205 (465). In an embodiment, the demand forecast may be or include a forecasted workload requirement of the service 205 at a future time. The forecasted workload requirement may then be compared to the workload capacity of the current resources 207. This comparison, which may be a ratio, may be compared to a demand threshold (482B). Similar to the operation threshold, in some embodiments, there may be a demand range instead of a single demand threshold, or there may be a second demand threshold such that the first demand threshold and the second demand threshold define an upper and lower bounds for how the compute engine 212 determines whether or not the current resources are over-or under-provisioned.

Since the demand efficiency 232 may indicate what portion of the current resources'207 workload capacity the demand forecast is estimated to consume, if the demand threshold is exceeded by the demand efficiency 232, this may indicate the current resources 207 may not have enough capacity to support the service 205 at the future time. As such, the compute engine 212 may recommend the new compute configuration 250 (486). It should be appreciated, that while the analysis of the operational efficiency 227 and the demand efficiency 232 are illustrated sequentially, they may be determined simultaneously or in any other sequence. For example, the compute engine 212 may determine that the operational efficiency 227 is slightly under-provisioned based on the comparison to the operational threshold but that based on the demand efficiency 232 (e.g., forecasted demand), the current resources 207 are sufficient. In such cases, the compute engine 212 may not recommend a new compute configuration, depending on how far in the future the demand forecast is, unless there is another compute configuration having a lower cost. Additionally, in some embodiments when the compute engine 212 determines that the operation threshold is exceeded (482A), the compute engine 212 may continue to determine the demand efficiency 232 (464) to also evaluate whether the demand forecast is met by the current resources 207 before continuing to recommend the new compute configuration (486).

If the compute engine 212 determines that the demand efficiency 232 does not exceed the demand threshold, then the compute engine 212 may determine that the current resources 207 meet the forecasted demand of the services 205 (484B). In such a case, the compute engine 212 may check the compute landscape to see if there is a compute configuration having the same or similar computing arrangement as the current resources 207 for less cost (488). That is, the compute engine 212 may query the compute catalog 203 to identify other compute configurations 240 that have similar computing arrangements to the current resources 207 but at a lower cost.

Referring now to FIG. 5, an example flow 500 for providing a compute engine 512 to a client device 502, according to an embodiment herein. As noted above, the client device 502, which may be the same or similar to the client device 102, may be associated with an organization or business that provides a service, such as the service 205 to end-users or consumers. As such, the client device 502 may interact with the compute engine 512 for managing provisioning of resources to support the service. In the illustrated flow 500, the service may be deployed using current resources, such as the current resources 207, and the compute engine 512 may be performing a periodic check of the service and its respective resources to determine whether there is a more efficient compute configuration available for the service.

As illustrated, the compute engine 512 may determine the current resources being used by the service (556), such as a respective resource bundle provisioned for the service. Based on the current resources, the compute engine 512 may determine a provisioning profile (558) of the current resources. As described above, this may include determining the hardware and/or software specifications of the current resources. In parallel or subsequently the compute engine 512 may retrieve or receive resource information of the current resources from a service platform 504 (516). The service platform 504, which may be the same or similar to the service platform 104, may monitor the service's usage of the currently provisioned resources (e.g., current resources 207). It should be appreciated that while the service platform 504 is illustrated as providing the resource usage information, depending on the architecture, the cloud provider or a third party may provide the resource usage information to the compute engine 512. In some embodiments, the compute engine 512 may request the resource usage information, while in other embodiments, the service platform 504 may periodically provide the information to the compute engine 512.

Responsive to receiving the resource usage information, the compute engine 512 may determine the current utilization of the current resources (560). As described above this may involve determining the operational efficiency and/or the demand efficiency of the current resources based on the resource usage information. Based on the current utilization, the compute engine 512 may determine the current compute landscape to identify whether there are any compute configurations that may be more efficient for the service. However, prior to analyzing the current compute landscape, the compute engine 512 may determine the provisioning policies that govern the service (542). As illustrated, the provisioning policies may be received from the client device 502 via an input (546) during the check, during a previous check, or during the deployment process of the current resources.

Based on the provisioning policies and the current utilization of the current resources, the compute engine 512 may transmit a query to the service platform 504 to determine the current compute landscape (539). As described above, this may involve querying a compute catalog 503 to identify compute configurations that meet the operational requirements of the service based on the current utilization. The service platform 504 may provide a response to the compute engine 512 including the compute configurations that meet these features. Based on the response, the compute engine 512 may determine the compute landscape (566). In some embodiments, the compute engine 512 may filter compute configurations based on the provisioning policies to determine a subset of compute configurations (567) that meet the required features of the provisioning policies. It should be appreciated that in some embodiments, the compute engine 512 may include the provisioning policies in the query (539), such that the response (540) includes the compute configurations that meet those requirements.

From the subset of compute configurations, the compute engine 512 may select a compute configuration that provides the most efficient option (572). As described above this may include a compute configuration that provides a computing arrangement that aligns with the operational requirements of the service without over-or under-provisioning resources, while maintaining a low cost. Responsive to selecting the compute configuration, the compute engine 512 may generate a recommendation (574) including the compute configuration and send the recommendation (554) to the client device 502. As noted above, the recommendation may notify the client device 502 that the compute engine 512 has identified the compute configuration as a more efficient option over the current resources. The recommendation may include details such as the current utilization of the current resources, resource savings, and/or cost savings achieved by changing to the selected compute configuration.

In the illustrated flow 500, the client device 502 may accept the recommended compute configuration (555). In such cases, the compute engine 512 may coordinate provisioning of the selected compute configuration (575). This may include generating and transmitting a provisioning request (577) identifying the selected compute configuration to the service platform 504.

Referring to FIG. 6, FIG. 6 illustrates a computing apparatus 691 that may be used for providing a compute engine and related functions, as described herein. For example, the client devices 102, 106A-C, 202, or 502 may be or include the computing apparatus 691. As illustrated, the computing apparatus 691 includes a processing system 692 that includes a microprocessor and other circuitry that retrieves and executes software 695 from storage system 693. The processing system 692 may be implemented within a single processing device but may also be distributed across multiple processing devices or sub-systems that cooperate in executing program instructions. Examples of the processing system 692 include general purpose central processing units, graphical processing units, application specific processors, and logic devices, as well as any other type of processing device, combinations, or variations thereof.

The storage system 693 may comprise any computer-readable storage media or medium readable by processing system 692 and capable of storing software 695. The storage system 693 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations the storage system 693 may also include computer readable communication media over which at least some of the software 695 may be communicated internally or externally. The storage system 693 may be implemented as a single storage device but may also be implemented across multiple storage devices or sub-systems co-located or distributed relative to each other. The storage system 693 may comprise additional elements, such as a controller capable of communicating with the processing system 692 or possibly other systems.

The software 695 (including compute engine process 696) may be implemented in program instructions and among other functions may, when executed by the processing system 692, direct the processing system 692 to operate as described with respect to the various operational scenarios, sequences, and processes illustrated herein. For example, the software 695 may include program instructions for implementing a compute engine and related functions, such as the process 300, the process 400, or the flow 500, as described herein. In some cases, the software 695 may cause one or more features of the compute engine process 696 to provide or display respective components to a user via a user interface system 699 inoperable communication with a client device, such as the client device 102.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. The software 695 may include additional processes, programs, or components, such as operating system software, virtualization software, or other application software. The software 695 may also comprise firmware or some other form of machine-readable processing instructions executable by the processing system 692.

In general, the software 695 may, when loaded into the processing system 692 and executed, transform a suitable apparatus, system, or device (of which computing apparatus 691 is representative) overall from a general-purpose computing system into a special-purpose computing system customized to generate features, functionality, and user experiences provided by the compute engine. Indeed, encoding the software 695 on the storage system 693 may transform the physical structure of the storage system 693. The specific transformation of the physical structure may depend on various factors in different implementations of this description. Examples of such factors may include, but are not limited to, the technology used to implement the storage media of the storage system 693 and whether the computer-storage media are characterized as primary or secondary storage, as well as other factors.

For example, if the computer readable storage media are implemented as semiconductor-based memory, the software 695 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 697 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between the computing apparatus 691 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

Examples are described herein in the context of systems and methods for providing a compute engine and related functions. Those of ordinary skill in the art will realize that the foregoing description is illustrative only and is not intended to be in any way limiting. Reference is made in detail to implementations of examples as illustrated in the accompanying drawings. The same reference indicators will be used throughout the drawings and the following description to refer to the same or like items.

Additionally, the foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure. In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application-and business-related constraints, and that these specific goals will vary from one implementation to another and from one developer to another.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a computing apparatus comprising: a computer-readable storage medium; a compute engine comprising processor-executable instructions stored on the computer-readable storage medium; and one or more processors coupled to the computer-readable storage medium and configured to execute the processor-executable instructions, wherein the processor-executable instructions, when executed by the one or more processors, direct the computing apparatus, to at least: determine current resources provisioned to provide one or more services within a cloud-based or hybrid environment; determine a provisioning profile for the current resources, wherein the provisioning profile comprises hardware specifications and software specifications of the current resources; determine a current utilization of the current resources by the one or more services based on the provisioning profile for the current resources; determine a current compute landscape comprising compute configurations, wherein the current compute landscape comprises supply data for the compute configurations; and select a compute configuration from the compute configurations for the one or more services based on the current utilization of the current resources and the current compute landscape.

Example 2 is the computing apparatus of any previous or subsequent Example, wherein: the processor-executable instructions to determine the current utilization of the current resources by the one or more services based on the provisioning profile, when executed by the one or more processors, further direct the computing apparatus to: determine an operational efficiency of the current resources for providing the one or more services, wherein the operational efficiency comprises a resource utilization of the current resources; and determine that the resource utilization of the current resources exceeds a resource utilization threshold; and the processor-executable instructions to select the compute configuration from the compute configurations for the one or more services, when executed by the one or more processors, further direct the computing apparatus to: select the compute configuration from the compute configurations based on the resource utilization of the current resources exceeding the resource utilization threshold.

Example 3 is the computing apparatus of any previous or subsequent Example, wherein: the processor-executable instructions, when executed by the one or more processors, further direct the computing apparatus to: determine one or more provisioning policies associated with the one or more services; the processor-executable instructions to determine the current compute landscape comprising the compute configurations, when executed by the one or more processors, further direct the computing apparatus to: filter the compute configurations based on the one or more provisioning policies to identify a subset of compute configurations, wherein the compute configurations meet the one or more provisioning policies; and the processor-executable instructions to select the compute configuration from the compute configurations for the one or more services, when executed by the one or more processors, further direct the computing apparatus to: select the compute configuration from the subset of compute configurations for the one or more services.

Example 4 is the computing apparatus of any previous or subsequent Example, wherein: the processor-executable instructions to determine the current utilization of the current resources by the one or more services based on the provisioning profile, when executed by the one or more processors, further direct the computing apparatus to: determine a demand efficiency of the current resources for providing the one or more services, wherein the demand efficiency comprises a demand forecast for the one or more services; and determine that the demand efficiency of the current resources exceeds a demand threshold; and the processor-executable instructions to select the compute configuration from the compute configurations for the one or more services, when executed by the one or more processors, further direct the computing apparatus to: select the compute configuration from the compute configurations based on the demand forecast.

Example 5 is the computing apparatus of any previous or subsequent Example, the processor-executable instructions to determine the current compute landscape comprising the compute configurations, when executed by the one or more processors, further direct the computing apparatus to: determine one or more security requirements associated with the one or more services; and identify the compute configurations based on the one or more security requirements.

Example 6 is the computing apparatus of any previous or subsequent Example, wherein the processor-executable instructions, when executed by the one or more processors, further direct the computing apparatus to: generate a recommendation comprising the compute configuration; and provide the recommendation to a client device associated with management of the one or more services.

Example 7 is a method comprising: determining, by a compute engine, current resources provisioned to provide one or more services within a cloud-based or hybrid environment; determining, by the compute engine, a provisioning profile for the current resources, wherein the provisioning profile comprises hardware specifications and software specifications of the current resources; determining, by the compute engine, a current utilization of the current resources by the one or more services based on the provisioning profile for the current resources; determining, by the compute engine, a current compute landscape comprising compute configurations, wherein the current compute landscape comprises supply data for the compute configurations; determining, by the compute engine, a compute configuration from the compute configurations for the one or more services based on the current utilization of the current resources and the current compute landscape; and generating, by the compute engine, a recommendation comprising the compute configuration for the one or more services.

Example 8 is the method of any previous or subsequent Example, wherein the compute configuration selected for the one or more services comprises a Stock Keeping Unit (SKU).

Example 9 is the method of any previous or subsequent Example, wherein determining, by the compute engine, the current utilization of the current resources by the one or more services comprises determining, by the compute engine, a resource utilization of the current resources by calculating at least one of: CPU (Central Processing Unit) utilization of the current resources; memory utilization of the current resources; network bandwidth utilization of the current resources; or storage utilization of the current resources.

Example 10 is the method of any previous or subsequent Example, wherein determining, by the compute engine, the current utilization of the current resources by the one or more services comprises: determining, by the compute engine, workload requirements for the one or more services; determining, by the compute engine, workload capacity of the current resources based on the provisioning profile; comparing, by the compute engine, the workload requirements of the one or more services to the workload capacity of the current resources; and determining, by the compute engine, the current utilization based on the comparison, wherein the current utilization comprises a ratio of the workload requirements to the workload capacity.

Example 11 is the method of any previous or subsequent Example, wherein determining, by the compute engine, the current compute landscape comprising the compute configurations comprises: determining, by the compute engine, one or more operational requirements of the one or more services based on the current utilization of the current resources; querying, by the compute engine, a compute catalog based on the current utilization of the current resources; and identifying, by the compute engine, the compute configurations based on the operational requirements of the one or more services.

Example 12 is the method of any previous or subsequent Example, determining, by the compute engine, the current utilization of the current resources by the one or more services comprises: determining, by the compute engine, an operational efficiency of the current resources for providing the one or more services; and determining, by the compute engine, a demand efficiency of the current resources for providing the one or more services.

Example 13 is the method of any previous or subsequent Example, wherein the method further comprises: determining, by the compute engine, that at least one of the operational efficiency or the demand efficiency exceeds a respective threshold; and generating, by the compute engine, the recommendation based on the at least one of the operational efficiency or the demand efficiency exceeding the respective threshold.

Example 14 is the method of any previous or subsequent Example, wherein: determining, by the compute engine, the current utilization of the current resources by the one or more services comprises: determining, by the compute engine, a demand efficiency of the current resources for providing the one or more services, wherein the demand efficiency comprises demand forecast based on historical data; and determining, by the compute engine, that the demand efficiency of the current resources exceeds a demand threshold; and determining, by the compute engine, the compute configuration from the compute configurations for the one or more services: determining, by the compute engine, the compute configuration for the one or more services based on the demand efficiency exceeding the demand threshold; and selecting, by the compute engine, the compute configuration based on the demand forecast based on the historical data.

Example 15 is a computer readable storage media comprising processor-executable instructions configured to cause one or more processors to: determine, by a compute engine, current resources provisioned to support one or more services; determine, by the compute engine, a provisioning profile for the current resources, wherein the provisioning profile comprises hardware specifications and software specifications of the current resources; determine, by the compute engine, a workload requirement of the one or more services; determine, by a compute engine, a current compute landscape comprising compute configuration, wherein the current compute landscape comprises supply data for currently available resources; and select, by the compute engine, a compute configuration from the compute configurations based on the workload requirement of the one or more services and the current compute landscape.

Example 16 is the computer readable storage media of any previous or subsequent Example, wherein the processor-executable instructions cause the one or more processors to further execute processor-executable instructions stored in the computer readable storage media to: determine, by the compute engine, an operational efficiency for the one or more services based on the workload requirement of the services and the provisioning profile of the current resources; and determine, by the compute engine, a current utilization of the current resources based on the operational efficiency; and the processor-executable instructions to determine, by the compute engine, the current compute landscape comprising the compute configurations cause the one or more processors to further execute processor-executable instructions stored in the computer readable storage media to: determine, by the compute engine, the compute configurations based on the current utilization of the current resources.

Example 17 is the computer readable storage media of any previous or subsequent Example, wherein: the processor-executable instructions cause the one or more processors to further execute processor-executable instructions stored in the computer readable storage media to: determine, by the compute engine, historical usage data associated with the one or more services; determine, by the compute engine, a demand forecast for the one or more services based on the historical usage data, wherein the demand forecast predicts resource utilization required for the one or more services at a future time; and the processor-executable instructions to select, by the compute engine, the compute configuration from the compute configurations cause the one or more processors to further execute processor-executable instructions stored in the computer readable storage media to: select, by the compute engine, the compute configuration from the compute configurations based on the demand forecast and the workload requirement of the one or more services.

Example 18 is the computer readable storage media of any previous or subsequent Example, wherein the processor-executable instructions to determine, by the compute engine, the current compute landscape comprising the compute configurations cause the one or more processors to further execute processor-executable instructions stored in the computer readable storage media to: determine, by the compute engine, one or more operational requirements of the one or more services based on current utilization of the current resources; determine, by the compute engine, one or more provisioning policies associated with the one or more services; query, by the compute engine, a compute catalog for available resources for supporting the one or more services; and determine, by the compute engine, the compute configurations from the compute catalog based on the operational requirements and the one or more provisioning policies of the one or more services.

Example 19 is the computer readable storage media of any previous or subsequent Example, wherein: the processor-executable instructions cause the one or more processors to further execute processor-executable instructions stored in the computer readable storage media to: determine, by the compute engine, one or more provisioning policies associated with the one or more services; and the processor-executable instructions to determine, by the compute engine, the current compute landscape comprising the compute configurations cause the one or more processors to further execute processor-executable instructions stored in the computer readable storage media to: determine the compute configurations from a compute catalog based on the one or more provisioning policies and the workload requirements of the one or more services.

Example 20 is the computer readable storage media of any previous or subsequent Example, wherein the processor-executable instructions cause the one or more processors to further execute processor-executable instructions stored in the computer readable storage media to: generate, by the compute engine, a recommendation comprising the compute configuration selected for the one or more services; and provide, by the compute engine, the recommendation to a client device associated with management of the one or more services.

What is claimed is:

1. A computing apparatus comprising:
a computer-readable storage medium;
a compute engine comprising processor-executable instructions stored on the computer-readable storage medium; and
one or more processors coupled to the computer-readable storage medium and configured to execute the processor-executable instructions, wherein the processor-executable instructions, when executed by the one or more processors, direct the computing apparatus, to at least:
determine current resources provisioned to provide one or more services within a cloud-based or hybrid environment;
determine a provisioning profile for the current resources, wherein the provisioning profile comprises hardware specifications and software specifications of the current resources;
determine a current utilization of the current resources by the one or more services based on the provisioning profile for the current resources;
determine a current compute landscape comprising compute configurations, wherein the current compute landscape comprises supply data for the compute configurations; and
select a compute configuration from the compute configurations for the one or more services based on the current utilization of the current resources and the current compute landscape.

2. The computing apparatus of claim 1, wherein:
the processor-executable instructions to determine the current utilization of the current resources by the one or more services based on the provisioning profile, when executed by the one or more processors, further direct the computing apparatus to:
determine an operational efficiency of the current resources for providing the one or more services, wherein the operational efficiency comprises a resource utilization of the current resources; and
determine that the resource utilization of the current resources exceeds a resource utilization threshold; and
the processor-executable instructions to select the compute configuration from the compute configurations for the one or more services, when executed by the one or more processors, further direct the computing apparatus to:
select the compute configuration from the compute configurations based on the resource utilization of the current resources exceeding the resource utilization threshold.

3. The computing apparatus of claim 1, wherein:
the processor-executable instructions, when executed by the one or more processors, further direct the computing apparatus to: determine one or more provisioning policies associated with the one or more services;
the processor-executable instructions to determine the current compute landscape comprising the compute configurations, when executed by the one or more processors, further direct the computing apparatus to:
filter the compute configurations based on the one or more provisioning policies to identify a subset of compute configurations, wherein the compute configurations meet the one or more provisioning policies; and
the processor-executable instructions to select the compute configuration from the compute configurations for the one or more services, when executed by the one or more processors, further direct the computing apparatus to:
select the compute configuration from the subset of compute configurations for the one or more services.

4. The computing apparatus of claim 1, wherein:
the processor-executable instructions to determine the current utilization of the current resources by the one or more services based on the provisioning profile, when executed by the one or more processors, further direct the computing apparatus to:
determine a demand efficiency of the current resources for providing the one or more services, wherein the demand efficiency comprises a demand forecast for the one or more services; and
determine that the demand efficiency of the current resources exceeds a demand threshold; and
the processor-executable instructions to select the compute configuration from the compute configurations for the one or more services, when executed by the one or more processors, further direct the computing apparatus to:
select the compute configuration from the compute configurations based on the demand forecast.

5. The computing apparatus of claim 1, the processor-executable instructions to determine the current compute landscape comprising the compute configurations, when executed by the one or more processors, further direct the computing apparatus to:
determine one or more security requirements associated with the one or more services; and
identify the compute configurations based on the one or more security requirements.

6. The computing apparatus of claim 1, wherein the processor-executable instructions, when executed by the one or more processors, further direct the computing apparatus to:
generate a recommendation comprising the compute configuration; and
provide the recommendation to a client device associated with management of the one or more services.

7. A method comprising:
determining, by a compute engine, a current resources provisioned to provide one or more services within a cloud-based or hybrid environment;
determining, by the compute engine, a provisioning profile for the current resources, wherein the provisioning profile comprises hardware specifications and software specifications of the current resources;
determining, by the compute engine, a current utilization of the current resources by the one or more services based on the provisioning profile for the current resources;
determining, by the compute engine, a current compute landscape comprising a compute configurations, wherein the current compute landscape comprises supply data for the compute configurations;
determining, by the compute engine, a compute configuration from the compute configurations for the one or more services based on the current utilization of the current resources and the current compute landscape; and
generating, by the compute engine, a recommendation comprising the compute configuration for the one or more services.

8. The method of claim 7, wherein the compute configuration selected for the one or more services comprises a Stock Keeping Unit (SKU).

9. The method of claim 7, wherein determining, by the compute engine, the current utilization of the current resources by the one or more services comprises determining, by the compute engine, a resource utilization of the current resources by calculating at least one of:
CPU (Central Processing Unit) utilization of the current resources;
memory utilization of the current resources;
network bandwidth utilization of the current resources; or
storage utilization of the current resources.

10. The method of claim 7, wherein determining, by the compute engine, the current utilization of the current resources by the one or more services comprises:
determining, by the compute engine, workload requirements for the one or more services;
determining, by the compute engine, workload capacity of the current resources based on the provisioning profile;
comparing, by the compute engine, the workload requirements of the one or more services to the workload capacity of the current resources; and
determining, by the compute engine, the current utilization based on the comparison, wherein the current utilization comprises a ratio of the workload requirements to the workload capacity.

11. The method of claim 7, wherein determining, by the compute engine, the current compute landscape comprising the compute configurations comprises:
determining, by the compute engine, one or more operational requirements of the one or more services based on the current utilization of the current resources;
querying, by the compute engine, a compute catalog based on the current utilization of the current resources; and
identifying, by the compute engine, the compute configurations based on the operational requirements of the one or more services.

12. The method of claim 7, determining, by the compute engine, the current utilization of the current resources by the one or more services comprises:
determining, by the compute engine, an operational efficiency of the current resources for providing the one or more services; and
determining, by the compute engine, a demand efficiency of the current resources for providing the one or more services.

13. The method of claim 12, wherein the method further comprises:
determining, by the compute engine, that at least one of the operational efficiency or the demand efficiency exceeds a respective threshold; and
generating, by the compute engine, the recommendation based on the at least one of the operational efficiency or the demand efficiency exceeding the respective threshold.

14. The method of claim 7, wherein:
determining, by the compute engine, the current utilization of the current resources by the one or more services comprises:
determining, by the compute engine, a demand efficiency of the current resources for providing the one or more services, wherein the demand efficiency comprises demand forecast based on historical data; and
determining, by the compute engine, that the demand efficiency of the current resources exceeds a demand threshold; and
determining, by the compute engine, the compute configuration from the compute configurations for the one or more services:
determining, by the compute engine, the compute configuration for the one or more services based on the demand efficiency exceeding the demand threshold; and
selecting, by the compute engine, the compute configuration based on the demand forecast based on the historical data.

15. A computer readable storage media comprising processor-executable instructions configured to cause one or more processors to:
determine, by a compute engine, current resources provisioned to support one or more services;
determine, by the compute engine, a provisioning profile for the current resources, wherein the provisioning profile comprises hardware specifications and software specifications of the current resources;
determine, by the compute engine, a workload requirement of the one or more services;
determine, by a compute engine, a current compute landscape comprising compute configuration, wherein the current compute landscape comprises supply data for currently available resources; and
select, by the compute engine, a compute configuration from the compute configurations based on the workload requirement of the one or more services and the current compute landscape.

16. The computer readable storage media of claim 15, wherein the processor-executable instructions cause the one or more processors to further execute processor-executable instructions stored in the computer readable storage media to:
determine, by the compute engine, an operational efficiency for the one or more services based on the workload requirement of the services and the provisioning profile of the current resources; and
determine, by the compute engine, a current utilization of the current resources based on the operational efficiency; and
the processor-executable instructions to determine, by the compute engine, the current compute landscape comprising the compute configurations cause the one or more processors to further execute processor-executable instructions stored in the computer readable storage media to:
determine, by the compute engine, the compute configurations based on the current utilization of the current resources.

17. The computer readable storage media of claim 15, wherein:
the processor-executable instructions cause the one or more processors to further execute processor-executable instructions stored in the computer readable storage media to:
determine, by the compute engine, historical usage data associated with the one or more services;
determine, by the compute engine, a demand forecast for the one or more services based on the historical usage data, wherein the demand forecast predicts resource utilization required for the one or more services at a future time; and
the processor-executable instructions to select, by the compute engine, the compute configuration from the compute configurations cause the one or more processors to further execute processor-executable instructions stored in the computer readable storage media to:
select, by the compute engine, the compute configuration from the compute configurations based on the demand forecast and the workload requirement of the one or more services.

18. The computer readable storage media of claim 15, wherein the processor-executable instructions to determine, by the compute engine, the current compute landscape comprising the compute configurations cause the one or more processors to further execute processor-executable instructions stored in the computer readable storage media to:
determine, by the compute engine, one or more operational requirements of the one or more services based on current utilization of the current resources;
determine, by the compute engine, one or more provisioning policies associated with the one or more services;
query, by the compute engine, a compute catalog for available resources for supporting the one or more services; and
determine, by the compute engine, the compute configurations from the compute catalog based on the operational requirements and the one or more provisioning policies of the one or more services.

19. The computer readable storage media of claim 15, wherein:
the processor-executable instructions cause the one or more processors to further execute processor-executable instructions stored in the computer readable storage media to:
determine, by the compute engine, one or more provisioning policies associated with the one or more services; and
the processor-executable instructions to determine, by the compute engine, the current compute landscape comprising the compute configurations cause the one or more processors to further execute processor-executable instructions stored in the computer readable storage media to:
determine the compute configurations from a compute catalog based on the one or more provisioning policies and the workload requirements of the one or more services.

20. The computer readable storage media of claim 15, wherein the processor-executable instructions cause the one or more processors to further execute processor-executable instructions stored in the computer readable storage media to:
generate, by the compute engine, a recommendation comprising the compute configuration selected for the one or more services; and
provide, by the compute engine, the recommendation to a client device associated with management of the one or more services.
